(19) United States
(12) Patent Application Publication
(10) Pub. No.: US 2004/0025642 A1
(43) Pub. Date: Feb. 12, 2004

(54) Ratchet pipe wrench

(76) Inventor: Chih-Ching Hsien, Taichung (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/216,403

(22) Filed: Aug. 12, 2002

(51) Int. Cl. B25B 13/00

(52) U.S. Cl. 81/58.2

(57) ABSTRACT

A ratchet pipe wrench includes a C-shaped head composed of two jaws and a ratchet mechanism is received in the head so as to engage with a C-shaped engaging member which is rotatably engaged with the space between the two jaws of the head. The C-shaped engaging member has a polygonal inner periphery so as to engage with an object such as a nut and a toothed outer periphery which is engaged with the ratchet mechanism. The tool can reciprocatingly rotate the object without removing the tool from the object.

### FIELD OF THE INVENTION

The present invention relates to a ratchet pipe wrench having a C-shaped head with a C-shaped engaging member rotatably received in the head to corporate with the ratchet mechanism. The engaging member includes a polygonal inner periphery for engaging with a nut and a toothed outer periphery for engaging with the ratchet mechanism.

### BACKGROUND OF THE INVENTION

A conventional wrench used on piping system is shown in FIG. 1 and an inherent shortcoming is that the jaws of the conventional wrench are wide and thick and the pipes are located very close to each other so that when rotating the wrench the jaws are blocked by the pipes around the object. FIG. 2 shows a conventional pipe wrench that has a thinner ring portion so that the wrench is convenient to rotate among the pipes. Nevertheless, the conventional wrench has to be disengaged from the object after it is rotated an angle which is limited especially when the space between the pipes is narrow. The frequent disengagement and engagement of the wrench and the object take a lot of time and reduce the efficiency of the work.

The present invention intends to provide a ratchet pipe wrench having a C-shaped engaging member so that the wrench may rotate the object without removing the tool from the object frequently.

### SUMMARY OF THE INVENTION

In accordance with one aspect of the present invention, there is provided a ratchet pipe wrench that comprises a C-shaped head and a C-shaped engaging member is rotatably received in the head and engaged with a ratchet mechanism in an inner periphery of the head of the wrench.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 shows a conventional wrench and a piping system;

FIG. 2 shows a conventional pipe wrench and a pipe system;

FIG. 3 is an exploded view to show the ratchet pipe wrench of the present invention;

FIG. 4 is a perspective view to show that the engaging member is rotatable in the head of the wrench tool of the present invention;

FIGS. 5 to 12 show the different embodiments of the toothed outer periphery of the engaging member;

FIG. 13 is a cross sectional view to show that the toothed outer periphery of the engaging member includes two inclined teeth and the positioning member includes two parts which secures the engaging in the head;

FIGS. 14 to 17 show different shapes of the flange of the engaging member, and

FIGS. 18 to 20 show different types of polygonal inner periphery of the engaging member.

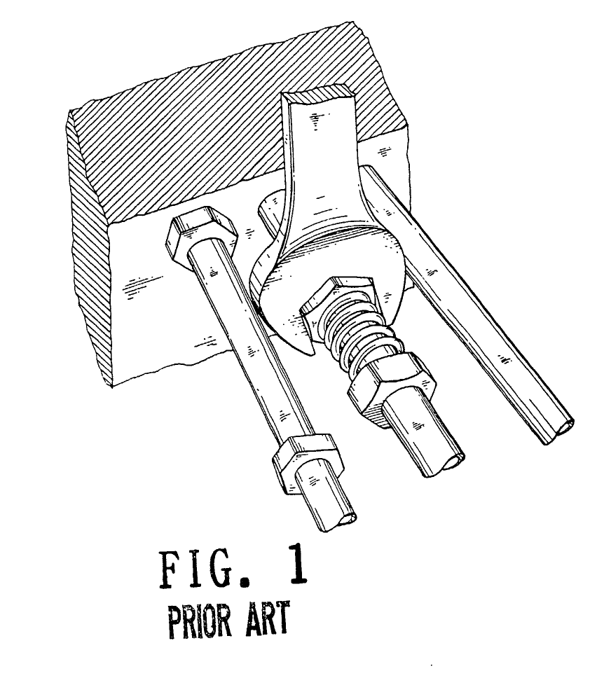

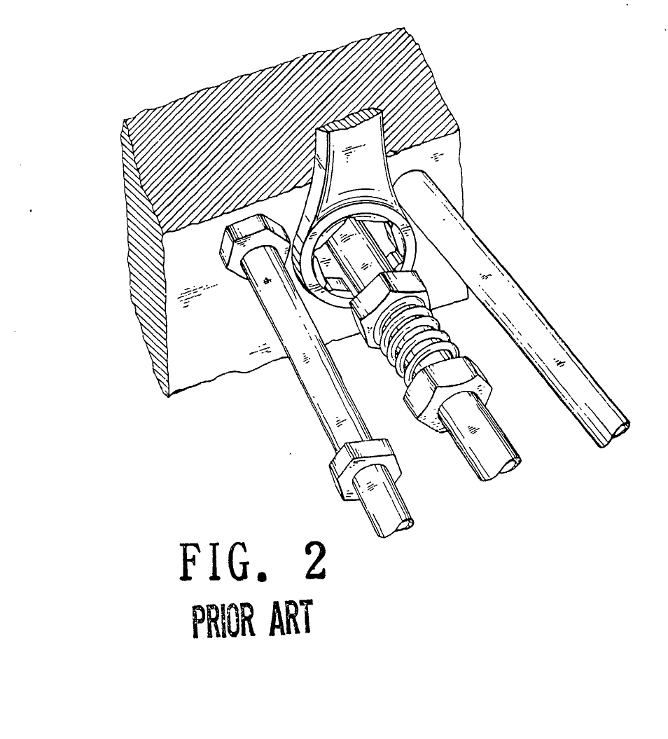

### DETAILED DESCRIPTION OF THE PREFERRED EMBODIMENT

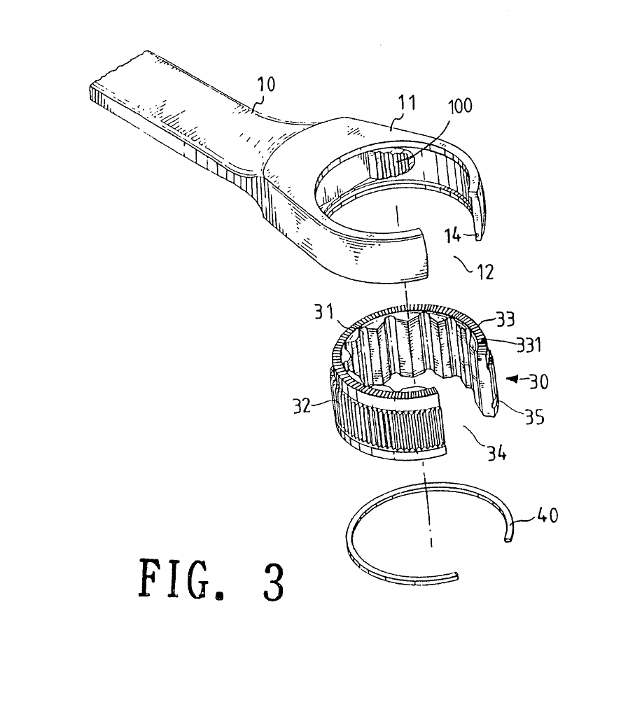

Referring to FIGS. 3 and 4, the ratchet pipe wrench 10 of the present invention comprises a C-shaped head 11 including two jaws and a ratchet mechanism 100 is received in an inner periphery of the head 11. A groove 14 is defined in the inner periphery of the head 11.

A C-shaped engaging member 30 is rotatably engaged with the space between the two jaws of the head 11 and has a toothed outer surface 32 which is engaged with the ratchet mechanism 100, and a polygonal inner periphery 31 which is engaged with an object such as a nut (not shown).

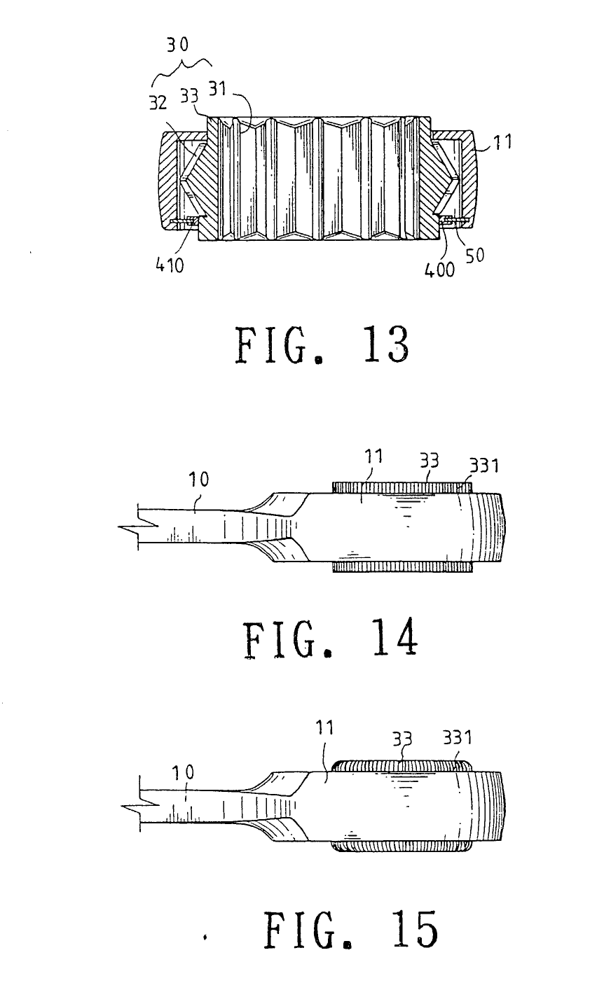

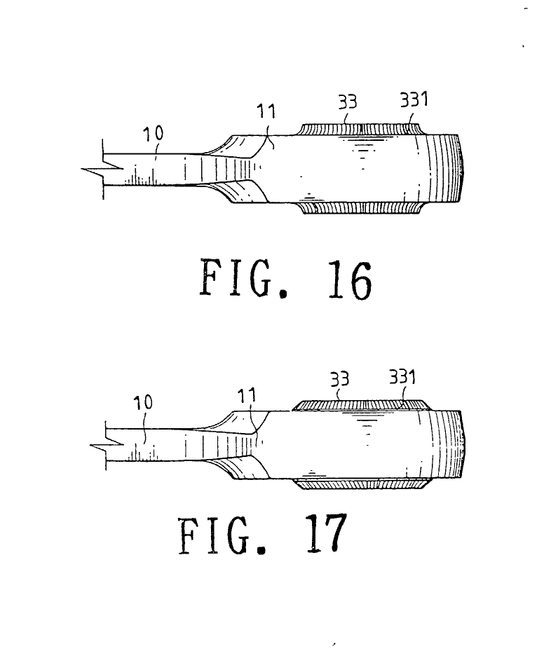

A C-shaped positioning ring 40 is securely engaged with the groove 14 defined in the two jaws of the head 11 and a groove 35 defined in an outer periphery of the engaging member 30 to secure the engaging member 30 which will not drop from the head 11. A flange 33 extends from a side of the engaging member 30 and protrudes from a surface of the head 11. The flange 33 has a knurled top surface 331 so that the user may rotate the engaging member 30 by touching the knurled top surface 331. Referring to FIGS. 14 to 17, the flange 33 may have different shapes as shown to meet requirements of the users.

The engaging member 30 is rotated with the rotation of the wrench 10 to tighten or loosen the object engaged with the engaging member 30, or the engaging member 30 is remained still while the wrench 10 is rotated. By the wrench 10, the user may reciprocatingly rotate the wrench 10 without removing the head 11 from the object. The engaging member 30 is also be rotated to a position such that the opening 34 of the engaging member 30 is in communication with the opening 12 of the head 11 such that the head 11 is disengaged from the object.

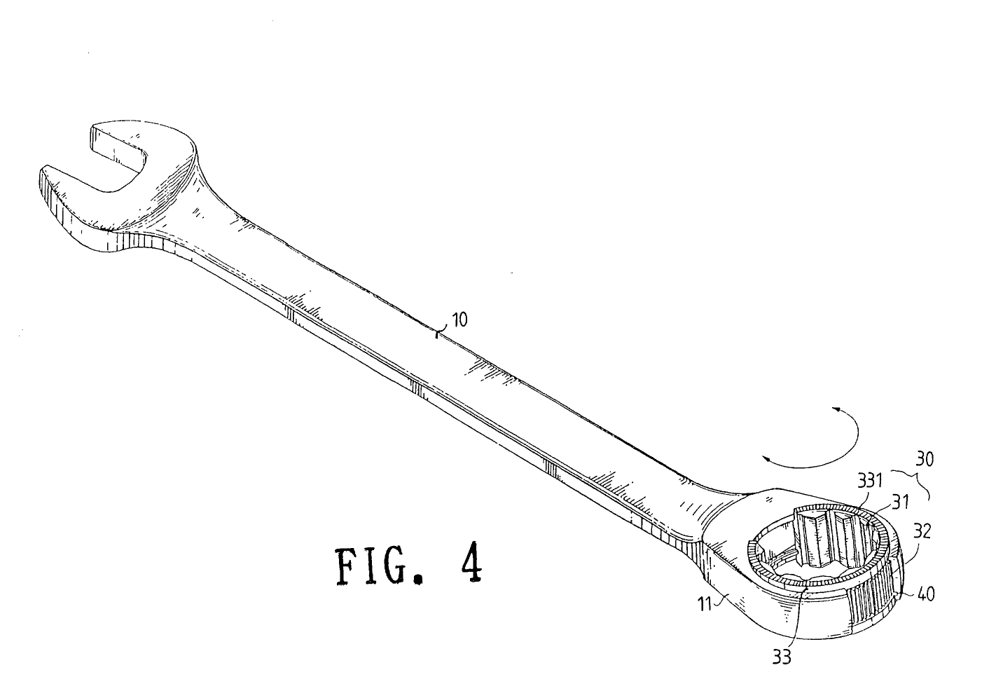

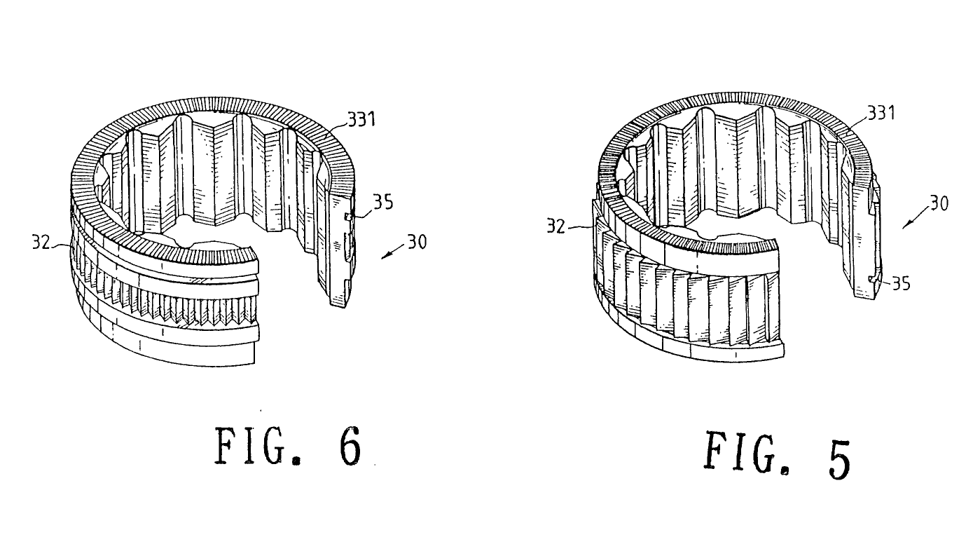

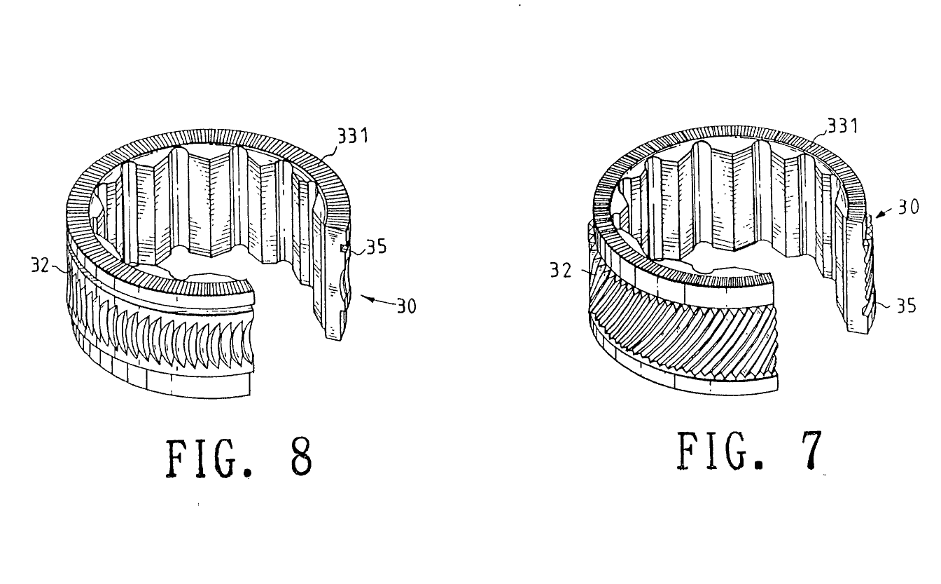

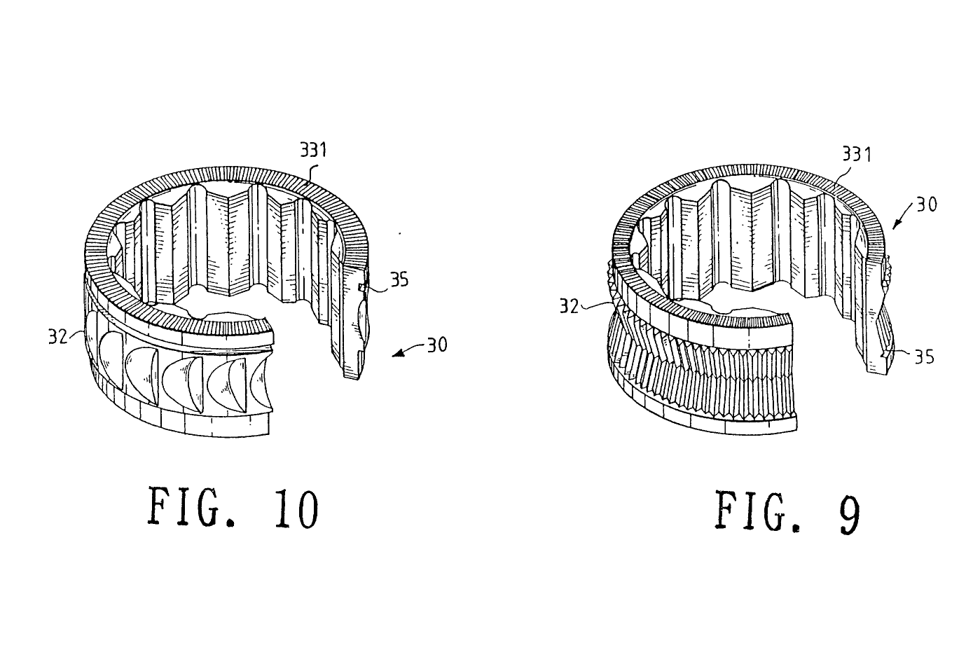

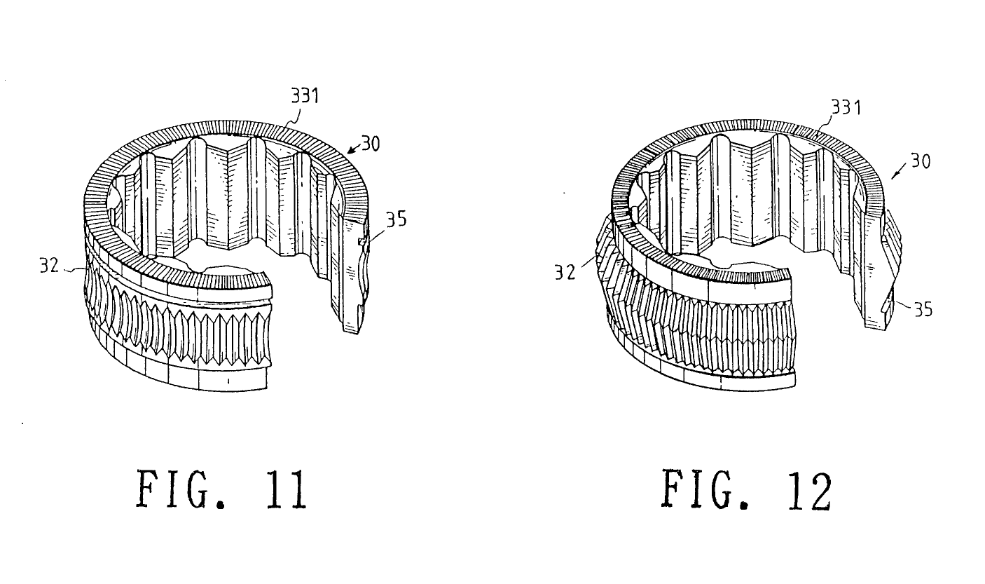

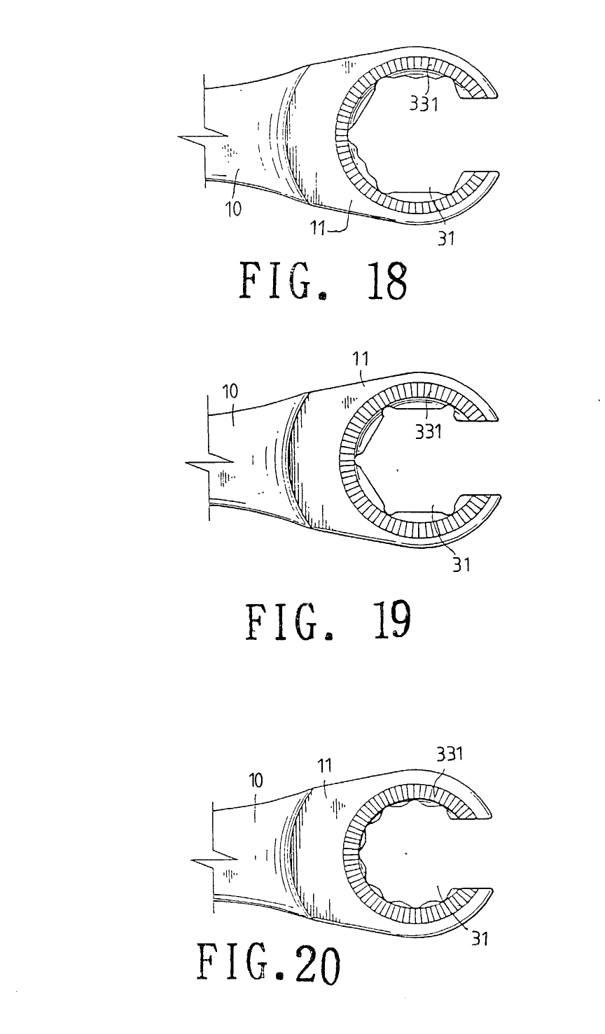

FIGS. 5 to 12 show that the toothed outer periphery 32 of the engaging member 30 may have these types of teeth as shown according to the required torque to be output. FIG. 13 shows that the engaging member 30 as shown in FIG. 12, which has two inclined teeth and protrudes outward from the engaging member 30. The positioning ring includes a first ring 400 which is engaged with the engaging member 30 and includes a groove 410 defined in an outside thereof. A second ring 50 which is engaged with the groove 14 of the head 11 and the groove 410 of the first ring 400. FIGS. 18 to 20 show different types of polygonal inner periphery 31 of the engaging member 30.

While we have shown and described the embodiment in accordance with the present invention, it should be clear to those skilled in the art that further embodiments may be made without departing from the scope of the present invention.

What is claimed is:

1. A ratchet pipe wrench comprising:
a C-shaped head including two jaws and a ratchet mechanism received in the head;
a C-shaped engaging member rotatably engaged with the space between the two jaws of the head and having a toothed outer surface which is engaged with the ratchet mechanism, the C-shaped engaging member having a polygonal inner periphery, and
a C-shaped positioning ring securely engaged with a groove defined in an inside of the two jaws of the head.

2. The pipe wrench as claimed in claim 1, wherein a flange extends from a side of the engaging member and protrudes from a surface of the head.

3. The pipe wrench as claimed in claim 2, wherein the flange has a knurled top surface.
